(19) United States
(12) Patent Application Publication
(10) Pub. No.: US 2017/0212768 A1
(43) Pub. Date: Jul. 27, 2017

(54) METHOD AND DEVICE FOR TRIGGERING A PROCESS

(71) Applicant: What Watch AG, Zurich (CH)

(72) Inventor: Igor Basargin, Yekaterinburg (RU)

(21) Appl. No.: 15/114,214

(22) PCT Filed: Jan. 27, 2014
(86) PCT No.: PCT/IB2014/058577

§ 371 Date: Jul. 26, 2016

(51) Int. Cl. G06F 9/445

(52) U.S. Cl. CPC G06F 9/445

(57) ABSTRACT

A controlling arrangement for triggering a process of a data related to an event in a communication application comprises a user related device. The user related device comprises a controlling means for outputting a triggering signal related to said event when manipulated the controlling means. The arrangement is configured to communicate said triggering signal from the user related device to a data processing means of the communication application, whereupon the data processing means is configured to launch said process of the data related to said event in the communication application.

### TECHNICAL FIELD OF THE INVENTION

The invention relates to a method and arrangement for triggering a process in a media, communication or diary application. Especially the invention relates to triggering a process of a data related to an event.

### BACKGROUND OF THE INVENTION

A number of media, communication or diary applications for processing, such as publishing, sharing, storing or delivering data related to an event, like photos and messages related to a special event or moment, are known from prior art. These applications may be open applications, like Facebook, Instagram or Twitter, where actually everybody may join, or these applications may be closed applications, like specially dedicated application for a certain platform. The closed applications are typically applications where only a certain closed group of people are joined, among which the data are communicated.

It is typical to the known applications that data to be processed, like a photo or message to be published, is written at the moment of the event and published at the same time. The photo and message may also be prepared beforehand and the processing can be programmed or timed so that it will be processed, like published after a certain time limit.

There are however some disadvantages relating to the known prior art, such as if exact time is needed or desired for the processing the data. Many events or moments are by the nature very fast or short, momentary, which makes it very challenging or even impossible to process the data exactly at the moment when it happens. Sometimes the event might be so exiting or dangerous that it is in practice impossible or unthinkable for anybody to concentrate to provide for example a message related to the event.

### SUMMARY OF THE INVENTION

An object of the invention is to alleviate and eliminate the problems relating to the known prior art. Especially the object of the invention is to provide an arrangement for triggering a process of a data related to an event very easily so that data, such as messages, photos, videos or the like, can be linked exactly to the moment of the event.

The object of the invention can be achieved by the features of independent claims.

The invention relates to an arrangement for triggering a process of a data related to an event according to claim 1. In addition the invention relates to a user related device according to claim 16, a method according to claim 17, and a computer program product according to claim 28.

According to an embodiment of the invention a controlling arrangement, as well as also a method, for triggering a process of a data related to an event comprises a user related device, which comprises a controlling means for outputting a triggering signal related to said event when manipulated the controlling means. The process may be for example publishing or storing or in other way manipulating a data, like message, image, video or link in a media, communication or diary application (hereinafter application or communication application). The event may be any event happened or other way related to the user, such as event related to work, leisure time, hobby, or other situations in life, like a birth of a baby or first jump by a parachute, or any unexpected event, such as an accident or incidence. It is to be noted that the triggering of the process launches the process, for example sets a time stamp for the event, whereupon the data related to the event can be added and published, stored or otherwise processed afterwards.

The user related device may be for example a mobile station, smart phone, computer or tablet computer with suitable hardware and software needed for a communication with a mobile network and managing said controlling devices. According to an embodiment the user related device comprises the communication application or at least suitable user interface to said communication application, via which the user can compose for example the messages to be processed as a result of the triggering signal. According to an example the application may be in a data communication with other applications located at the other user related devices (e.g. friend's devices) via a communication application server located at a data network. For the bidirectional communication the user related device is advantageously arranged in a bidirectional data communication connection with the communication application or network server hosting the communication application environment. In addition, according to an example, the user related device may also comprise an auxiliary device attached to a body of the user, for example to provide physiological data of the user.

According to an example, in order to take the application or device in use, the application or device must be activated for example by inputting a serial number of the application or device and/or by creating an account or profile to the application (for example into the user related device or server hosting said application). It is to be noted that the account or profile may comprise open portions, which can be shared for example to other people belonging to the same group in the application, or the account or profile may comprise closed or confidential portions, which are not open for anybody than the owner (like a confidential diary).

The controlling means may be for example a special button, e.g. so called stop button or touch sensor of the user related device, which captures a time (time stamp) when pressed or other way manipulated. According to an example time of the wrist watch or other related device is “stopped” at the moment of the event and captured for the processing of the data. According to exemplary embodiments the controlling means may also be other type of controlling means, such as G-force sensor, GPS or other location sensing means, altimeter or barometer, temperature sensor or speed indicator as an example, which is capable of outputting said triggering signal related to said event, when manipulated the controlling means, such as when the button is pressed, or parameter determined by the controlling means exceeds or deceeds a certain predetermined limit or value. It is to be understood that these controlling means are only examples and also other type of sensors suitable for measuring physical quantities from the environment is possible to use as said controlling means, such as or physiological signal measuring device, for example heart rate monitor or blood pressure monitor.

When the controlling means is manipulated, it outputs said triggering signal, which is communicated from the user related device to a data processing means of the communication application at a network server, for example, whereupon the data processing means is configured to launch said process of the data related to the event in said communication application. It is to be noted that the triggering signal may be communicated to the data processing means by the user related device or an auxiliary communication means may be used between the user related device and the data processing means, such as a proxy server or the like, which is capable of receiving said triggering signal from the user related device and again transferring it to said data processing means. Again it is to be noted that said data processing means may be comprised by said auxiliary communication means, or the data processing means may be at a cloud server, for example, depending on the communication application for processing said data. According to an example the data processing means may also be located at the user related device.

According to an embodiment the user related device communicates at least portion of the data to be processed to the data processing means of the communication application in addition to said triggering signal. As an example, when the controlling means is manipulated (e.g. a stop button is pressed) the triggering signal, comprising advantageously a time stamp, is transmitted by the user related device to the data processing means. According to an example the data, like photos and messages, related to the event may be produced after the event and coupled afterwards to the time stamp of the event. The data can be produced by the user related device, but according to the example at least portion of the data to the process may also be provided by other device. For example, if the time stamp and message is send by the user related device to the cloud server, additional data, like video or images, can be added afterwards related to the same event for example by computer being connected to said cloud server and having access to said process of the data related to said event.

According to another exemplary embodiment at least portion of the data to be processed may also be provided before the event and stored in a memory means. The memory means may be memory means of the user related device or the communication application (such as an account at the communication application server at the network), or other memory means of any external server being in data communication with the communication application. In this example the user typically has some knowledge about the coming event. He might know e.g. that he is jumping with a parachute, whereupon he can write a message before the event and store it to the memory means. Then, when manipulating the controlling means (like pressing the stop button or sensing zero gravity by the G-force sensor for a certain time), the triggering signal is output, whereupon the processing means of the application processes said data related to said event, like publish the message written beforehand in the communication application.

It is to be noted that a time limit estimation for the assumed event to be happened may be provided to the user related device before the event, whereupon the user related device advantageously provides a reminder or indicator, such as an alarm or visual indication on its display of the assumed event to be happened. The time limit estimation may be communicated to the user related device by the communication application server, for example.

Still according to an embodiment also location data of the user related device can be added when manipulating said controlling means of the user related device.

In addition, according to an exemplary embodiment at least two controlling means may be used, which means that in order to provide the triggering signal related to said event, the parameters by both of the controlling means must fulfil a certain predetermined condition. For example the stop button sends the triggering signal only if the user related device is within a certain GPS-location or other predetermined parameter requirement is fulfilled.

Furthermore, according to an example the event can be created to the application or profile in the application also afterwards e.g. via the application or its user interface. For example when the user is creating his account or profile, event already happened in the past can be added and data related to these events can be processed, like added, shared, etc.

Again, according to an embodiment symbols related to the events managed by the application can be shown or displayed in the display means of the user related device. The layout or the user interface of the applications may for example have a certain symbol, like a bar or circle, like coloured circle, denoting one or more event. When there is plurality of event in the user's account, the display of the device (or account) will be personalized expressing the activity of the user (more the symbols, more active the user).

The location of the signs in the display may be chosen freely, but according to an embodiment event happened in a certain month is shown in a certain sector dedicated for that month, etc. According to an example the view of the current display can be “frozen” and/or stored in the memory means for example of the user related device or other external system, whereupon it can be restored, viewed or used as a screen saver or the like and thus additionally expressing the activity of the user.

The invention offers many advantages over the known prior art, such as offers essentially complete freedom for the user to enjoy at the moment of the event and still capturing or performing a certain acts related to said event without any massive demands for the users.

### BRIEF DESCRIPTION OF THE DRAWINGS

Next the invention will be described in greater detail with reference to exemplary embodiments in accordance with the accompanying drawings, in which:

FIG. 1 illustrates a principle of an exemplary arrangement for triggering a process of a data related to an event according to an advantageous embodiment of the invention.

### DETAILED DESCRIPTION

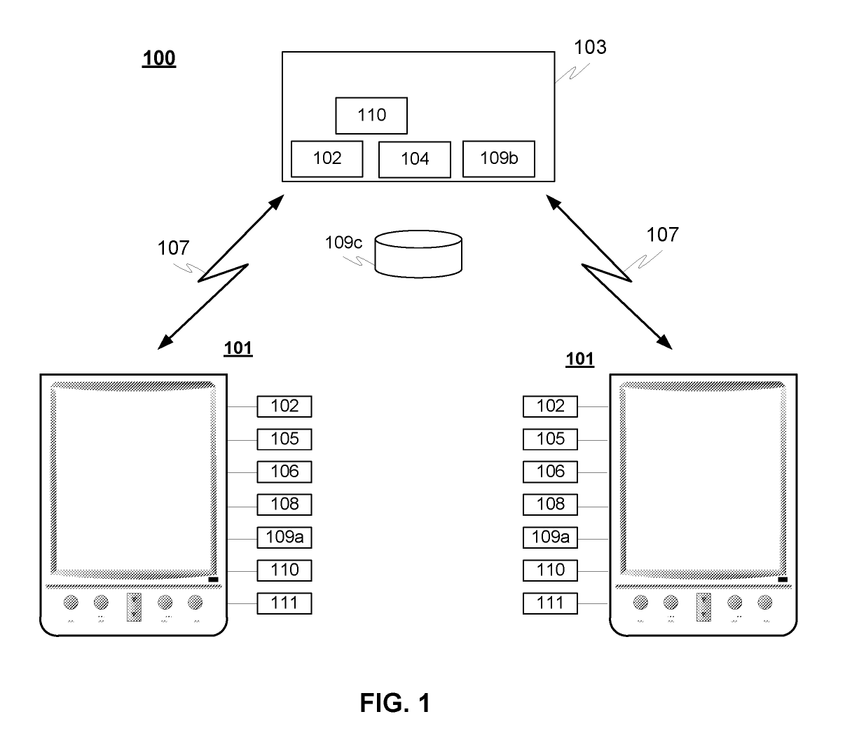

FIG. 1 illustrates a principle of an exemplary arrangement 100 for triggering a process of a data related to an event in a communication application 102 according to an advantageous embodiment of the invention, wherein, wherein the arrangement comprises a user related device 101 and advantageously an application server 103 hosting data transfer between the user related devices in the arrangement. According to an embodiment the application server 103 may also host at least portion of the communication application 102 and comprise also suitable data processing means 104 for processing data. However, it is to be noted that also the user related device 101 may comprise at least portion of said communication application 102 or at least suitable user interface means to said communication application 102. In addition the user related device may also comprise suitable data processing means 105 for processing data.

The user related device comprises at least one controlling means 106 for outputting a triggering signal related to the event, when the controlling means is manipulated. The controlling means may be for example a special dedicated button, such as a so called stop button, or a sensor configured to detect a certain measurable environmental quantity, as is disclosed elsewhere in this document.

When the controlling means 106 is manipulated, it triggers a signal, which is communicate to the data processing means 104 (or optionally at least partially to 106) of the communication application. The data processing means 104, 106 is then configured to launch the process of the data related to the event in the communication application.

The user related device 101 is for example a mobile station, smart phone, computer or tablet computer or other device with suitable hardware and software needed for a communication with a mobile network and managing said controlling means. The user related device may be in a bidirectional data communication 107 with the data processing means of the communication application.

The user related device 101 comprises suitable communication means 108, such as 3G or 4G device configured to transfer data between said application server 103 and the user related device and thereby enabling also data transfer between the communication applications of the different user related devices 101 in the arrangement.

In addition the arrangement comprises a memory means for storing the data to be processed. The memory means may be memory means 109a of the user related device, memory means 109b of the communication application server, or other memory means 109c of any external server being in data communication with the communication application.

The user related device comprises also timing means 110, which is configured to provide a time stamp when the controlling means is manipulated and the triggering signal is output. Timing means may be an internal timer or the user related device, or an application receiving timing information from an external source, such as from a data network. It is to be noted that the timing means 110 may also be utilized at the application server 102, where it is configured to provide the time stamp when receiving said triggering signal.

The user related device may also comprise a positioning means 111, such as a GPS or cellular based positioning system, which is configured to provide location data of the user related device for example when the controlling means of the user related device is manipulated. The location data can also be sent to the application server and related to the event or data to be processed.

As discussed elsewhere in this document, the user related device may comprise at least two different controlling means for detecting different quantities, whereupon the user related device may be configured to output the triggering signal related to said event only when parameters detected by both of the controlling means are in a certain predetermined limit. For example the pressing of the stop button sends the triggering signal only if the user related device is within a certain GPS-location or when another parameter of another controlling means matches to a predetermined value or range.

The invention has been explained above with reference to the aforementioned embodiments, and several advantages of the invention have been demonstrated. It is clear that the invention is not only restricted to these embodiments, but comprises all possible embodiments within the spirit and scope of the inventive thought and the following patent claims.

According to an example the user related device or application (implemented for example by a software) may be bought for example as a gift, whereupon the gift giver may create a profile and history to the account related to the device (or user) of the events already passed, and thereby share e.g. the common moments of their life with the gift receiver. Of course also upcoming events can be created beforehand, correspondingly as has been disclosed in this document elsewhere. It is to be that at least part of the accounts or profiles may be common (copied or shared) for two or more users, such as for a couple, whereupon they both can share data related to e.g. their first dating, first travelling or any other common moments lived together. Again it is to be noted that at least portion of the accounts or profiles may be denoted as a confidential or personal, whereupon that part is managed as a personal diary and that data is available only to the user of the device.

1. A controlling arrangement for triggering processing of data related to an event in a communication application, comprising:
a user related device comprising a control constructed and operable for outputting a triggering signal related to said event when the control is activated;
a communicator configured to communicate said triggering signal from the user related device to a data processor of the communication application, whereupon the data processor is configured to launch said processing of the data related to said event in the communication application.

2. A controlling arrangement of claim 1, wherein the user related device is a device selected from the group comprising: a mobile station, a smart phone, a computer, and a tablet computer.

3. A controlling arrangement of claim 1, wherein the user related device is configured to be in a bidirectional data communication with the data processor of the communication application.

4. A controlling arrangement of claim 3, wherein the user related device is configured to communicate at least a portion of the data to be processed to the data processor of the communication application in addition to said triggering signal.

5. A controlling arrangement of claim 1, wherein at least portion of said data related to said event is produced before the event and stored in a memory, whereupon when outputting said triggering signal, the data processor of the communication application is configured to process said data related to said event in the communication application.

6. A controlling arrangement of claim 5, wherein an estimated time for an event that is assumed will happen is provided to said user related device before the event, whereupon said user related device is configured to provide a reminder or indicator of the event that is assumed will happen.

7. A controlling arrangement of claim 1, wherein the arrangement is configured to provide a time stamp of the event for the data processor of the communication application, when outputting said triggering signal.

8. A controlling arrangement of claim 7, wherein at least a portion of said data related to said event is produced after the event and coupled to said time stamp.

9. A controlling arrangement of claim 1, wherein the user related device comprises a data communicator constructed and operable for communicating data to the data processor of the communication application.

10. A controlling arrangement of claim 1, wherein the arrangement is configured to provide location data of the user related device when the control of the user related device is activated.

11. A controlling arrangement of claim 1, wherein the control includes a control device selected from the group consisting of: a button, a G-force sensor, a GPS receiver, an altimeter, a barometer, a temperature sensor, a speed indicator, or a physiological signal measuring device configured for outputting said triggering signal related to said event, when the control device is activated, the control device by being pressed or when a parameter passes a predetermined threshold.

12. A controlling arrangement of claim 1, wherein the control comprises at least two controls, the at least two controls being configured for outputting said triggering signal related to said event when parameters detected by both of the at least two controls pass respective predetermined thresholds.

13. A controlling arrangement of claim 1, wherein the data to be processed is one of a text message, image, video, or link to a data content.

14. A controlling arrangement of claim 1, wherein the arrangement is configured to provide a profile for the events of a user, and wherein the arrangement is configured to add events passed to the profile.

15. A controlling arrangement of claim 1, wherein the user related device comprises a display, and wherein the user related device is configured to display a symbol related to each event on the display.

16. (canceled)

17. A method for triggering processing of data related to an event in a communication application, comprising:
activating a control of a user related device to output a triggering signal related to said event;
communicating said triggering signal from the user related device to a data processor of the communication application, whereupon the data processor launches said processing of the data related to said event in the communication application.

18. A method claim 17, wherein the user related device is in a data communication with the data processor of the communication application.

19. A method claim 18, wherein the user related device communicates at least portion of the data to be processed to the data processor of the communication application in addition to said triggering signal.

20. A method of claim 17, wherein at least a portion of said data related to said event is produced before the event and stored in a memory of at least one of the user related device and the communicator, whereupon when outputting said triggering signal, the processor of the communication application processes said data related to said event in the communication application.

21. A method claim 20, wherein an estimated time for an event that is assumed will happen is provided to said user related device before the event, whereupon said user related device provides a reminder or indicator of the event that is assumed will happen.

22. A method of claim 1, further comprising:
providing a time stamp of the event for the data processor of the communication application when outputting said triggering signal.

23. A method of claim 22, wherein at least portion of said data related to said event is produced after the event and coupled to said time stamp.

24. A method of claim 17, further comprising: providing location data of the user related device when said control is activated.

25. A method of claim 17, further comprising: outputting said triggering signal related to said event when parameters detected by at least two different controls exceed respective thresholds.

26. A method of claim 17, wherein the communication application is one of an open or closed application.

27. A method of claim 17, wherein the data to be processed is one of a text message, image, video, or link to a data content.

28. A computer program product for triggering processing of data related to an event in a communication application, comprising:
program code stored on a computer-readable medium, the program code being executable to perform the method comprising:
activating a control of a user related device to output a triggering signal related to said event;
communicating said triggering signal from the user related device to a data processor of the communication application, whereupon the data processor launches said processing of the data related to said event in the communication application.
